(19) United States
(12) Patent Application Publication
(10) Pub. No.: US 2026/0304190 A1
(43) Pub. Date: Oct. 1, 2026

(54) METHODS AND DEVICES FOR FORMING MEASUREMENT RESULTS UNDER AGGREGATION TRANSMISSION

(71) Applicant: ZTE CORPORATION, Shenzhen, Guangdong (CN)

(72) Inventors: Wei GOU, Shenzhen (CN); Xianghui HAN, Shenzhen (CN); Shuaihua KOU, Shenzhen (CN); Jing SHI, Shenzhen (CN)

(21) Appl. No.: 19/480,488

(22) PCT Filed: May 24, 2023
(86) PCT No.: PCT/CN2023/096055

§ 371 Date: Oct. 31, 2025

(51) Int. Cl. H04W 24/10; H04L 5/00

(52) U.S. Cl. CPC H04W 24/10; H04L 5/0051

(57) ABSTRACT

A method for wireless communication, including: forming measurement result under user equipment (UE) aggregation transmission, where a first UE and a second UE are paired for the UE aggregation transmission, by: determining, by at least one of the first UE and the second UE, channel state information reference signal (CSI-RS) resources; performing. by the at least one of the first UE and the second UE, measurement by using the determined CSI-RS resources; generating, by the at least one of the first UE and the second UE, a measurement report; and reporting, by the at least one of the first UE and the second UE, the measurement report to a base station.

### CROSS-REFERENCE TO RELATED APPLICATION(S)

This application is a national phase entry under 35 USC 371 of International Patent Application No. PCT/CN2023/096055 filed on May 24, 2023, and the entire content of the International Patent Application is incorporated into this application by reference.

### TECHNICAL FIELD

The present disclosure is directed generally to wireless communications. Particularly, the present disclosure relates to methods and devices for forming measurement results under aggregation transmission.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

In some wireless communication schemes, user equipment (UE) aggregation transmission may be used to improve throughout or reliability of transmission from a UE, for example, when the UE is at a cell edge of a base station. There are many problems/issues associated with operations of UE aggregation transmission. For example, one problem/issue may include how to determine reference signal resource for measuring channel state under the UE aggregation transmission; another problem/issue may include how to form and/or report measurement results under the UE aggregation transmission.

The present disclosure describes various embodiments for determining UE aggregation transmission, addressing at least one of the issues/problems discussed above, improving performance of the wireless communication, particularly achieving efficient formation of measurement results under UE aggregation transmission and/or improving throughput and/or reliability of UE's transmission.

### SUMMARY

This document relates to methods, systems, and devices for wireless communication, and more specifically, for forming measurement results under aggregation transmission. The various embodiments in the present disclosure may increase the resource utilization efficiency, enhance coverage, and/or improve throughput and/or reliability of UE's transmission.

In one embodiment, the present disclosure describes a method for wireless communication. The method includes forming measurement result under user equipment (UE) aggregation transmission, wherein a first UE and a second UE are paired for the UE aggregation transmission, by: determining, by at least one of the first UE and the second UE, channel state information reference signal (CSI-RS) resources; performing, by the at least one of the first UE and the second UE, measurement by using the determined CSI-RS resources; generating, by the at least one of the first UE and the second UE, a measurement report; and reporting, by the at least one of the first UE and the second UE, the measurement report to a base station.

In one embodiment, the present disclosure describes a method for wireless communication. The method includes configuring, by a base station, CSI-RS resources; receiving, by the base station, a measurement report under UE aggregation transmission, wherein a first UE and a second UE are paired for the UE aggregation transmission, and at least one of the first UE and the second UE determines CSI-RS resources, performs measurement by using the determined CSI-RS resource, generates and report the measurement report.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods. The computer-readable medium includes a non-transitory computer-readable medium.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of an exemplary method for wireless communication.

FIG. 4B shows a flow diagram of another exemplary method for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for forming measurement results under user equipment (UE) aggregation transmission.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

In some wireless communication schemes, user equipment (UE) aggregation transmission may be used to improve throughout or reliability of transmission from a UE, for example, when the UE is at a cell edge of a base station. There are many problems/issues associated with operations of UE aggregation transmission. For example, one problem/issue may include how to determine reference signal resource for measuring channel state under the UE aggregation transmission; another problem/issue may include how to form and/or report measurement results under the UE aggregation transmission.

The present disclosure describes various embodiments for determining UE aggregation transmission, addressing at least one of the issues/problems discussed above, improving performance of the wireless communication, particularly achieving efficient transmission of UE aggregation transmission and improving throughput and/or reliability of UE's transmission.

In some implementations, the UE aggregation transmission may be divided into a plurality of modes, for example, a transparent mode and a non-transparent mode. In the transparent mode, the base station may be unaware that a group of UEs (e.g., a first UE (UE1) and a second UE (UE2)) are paired for UE aggregation transmission. In the non-transparent mode, the base station knows that the group of UEs are paired for UE aggregation transmission, and knows that one UE's data may be transmitted by another UE, for example, the base station may know that the UE1's data may be transmitted by the UE2.

In some implementations, transparent mode may have some drawbacks that lead to inefficiency. For one non-limiting example, a channel environment (such as channel state information (CSI), interference, etc.) of the UE1 and the UE2 may be different. The base station may not be aware that the UE1 and the UE2 are paired to perform the UE aggregation transmission, and thus, the base station may always configure parameter values in the UE1's uplink (UL) grant based on the UE1's channel environment. The UE1's data is ultimately transmitted by the UE2 based on the UE2's channel environment. Obviously, in this case, when the UE1's data is transmitted by the UE2, the parameters matching UE2's channel environment are not used and it may lead to inefficiency.

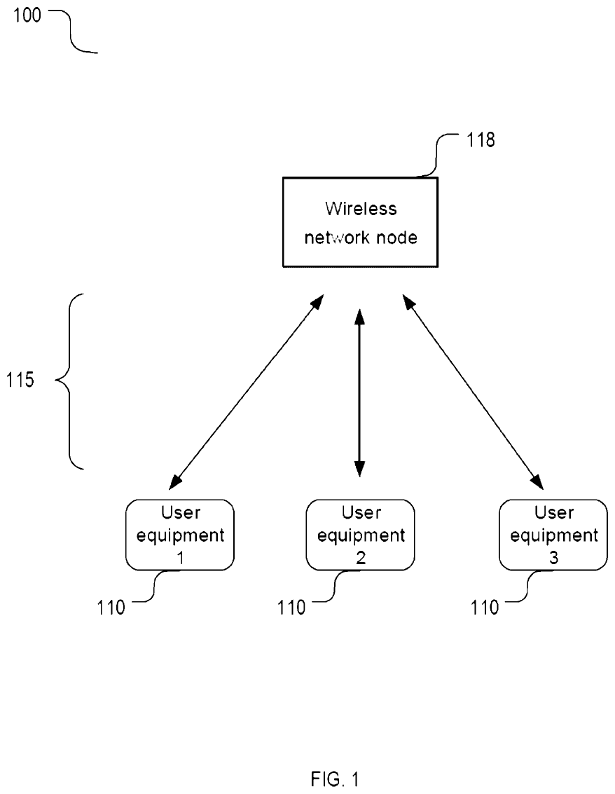

FIG. 1 shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

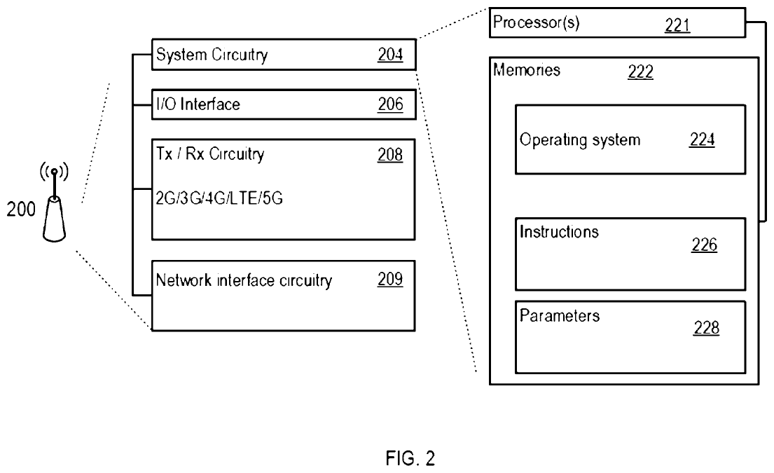

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

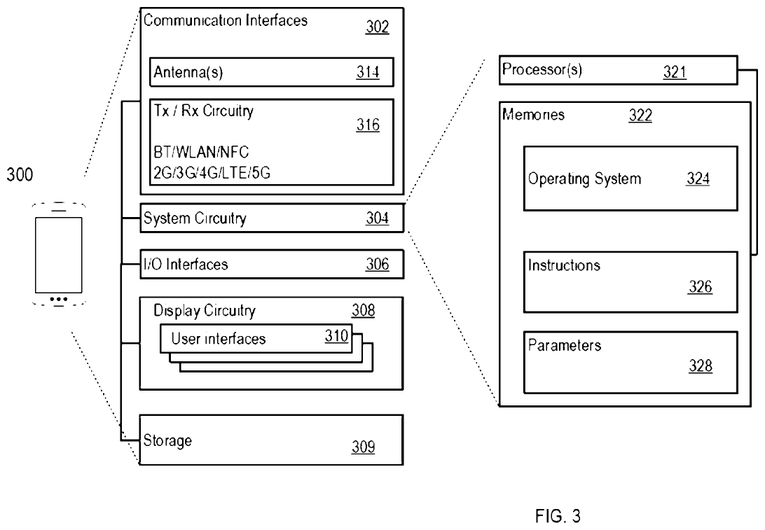

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for forming measurement results under user equipment (UE) aggregation transmission, which may be implemented, partly or totally, on the network base station and/or the user equipment described above in FIGS. 2-3.

In various embodiments in the present disclosure, when a group of UEs are in UE aggregation transmission, each UE in the group may have its role type.

For one non-limiting example, when a first UE (UE1) and a second UE (UE2) are paired for UE aggregation transmission, the UE1's data is transmitted to the base station by the UE2, and the UE2's data is not transmitted to the base station by the UE1, the UE1 and the UE2 may represent different role types: the UE1 may have a role type of an anchor UE and the UE2 may have a role type of an assistant UE. In some implementations, the UE1's data may include UE1's uplink control information (UCI), for example, hybrid automatic repeat request acknowledgement (HARQ-ACK), scheduling request (SR), channel state information (CSI), etc.

For another non-limiting example, when a first UE (UE1) and a second UE (UE2) are paired for UE aggregation transmission, the UE1's data is transmitted to the base station by the UE2, and the UE2's data is transmitted to the base station by the UE1, the UE1 and the UE2 may represent a role type of mutual UEs: the UE1 may have a role type of an anchor UE and a role type of an assistant UE; and the UE2 may have a role type of an assistant UE and a role type of an anchor UE.

In various embodiments, the anchor UE and the assistant UE may be called as master UE and slave UE, respectively, or primary UE and secondary UE, respectively.

The present disclosure describes various embodiment for forming measurement results under user equipment (UE) aggregation transmission, at least addressing some of the problems/issues described above, for example, how channel state information (CSI) measurement results of the UE1 and the UE2 are multiplexed and/or reported.

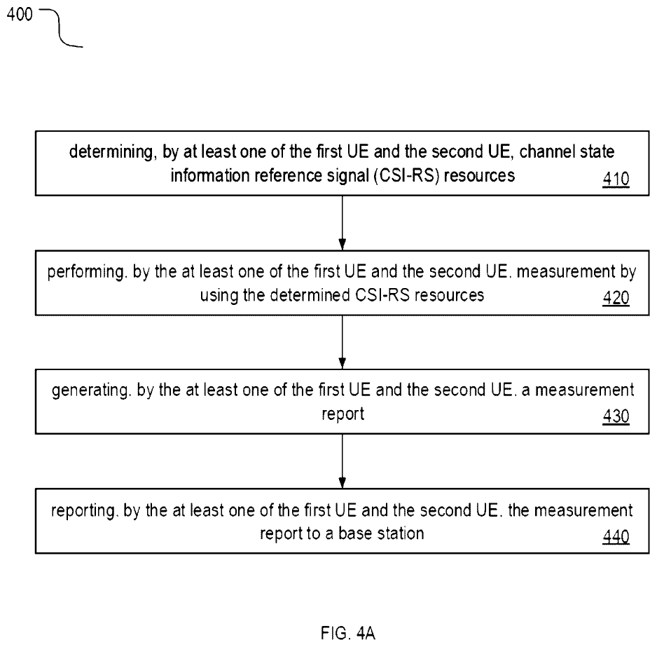

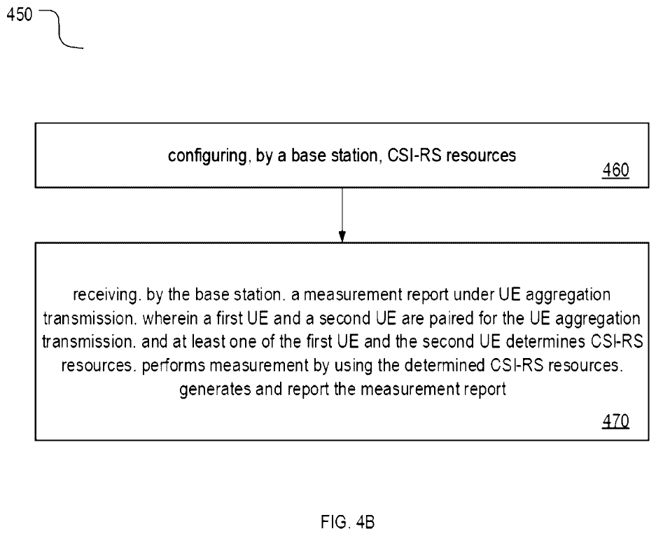

Referring to FIG. 4A, the present disclosure describes various embodiments of a method 400 for wireless communication including forming measurement result under user equipment (UE) aggregation transmission, wherein a first UE and a second UE are paired for the UE aggregation transmission. The method 400 may include a portion or all of the following steps: step 410, determining, by at least one of the first UE and the second UE, channel state information reference signal (CSI-RS) resources; step 420, performing, by the at least one of the first UE and the second UE, measurement by using the determined CSI-RS resources; step 430, generating, by the at least one of the first UE and the second UE, a measurement report; and step 440, reporting, by the at least one of the first UE and the second UE, the measurement report to a base station.

Referring to FIG. 4B, the present disclosure describes various embodiments of a method 450 for wireless communication. The method 450 may include a portion or all of the following steps: step 460, configuring, by a base station, CSI-RS resources; and step 470, receiving, by the base station, a measurement report under UE aggregation transmission, wherein a first UE and a second UE are paired for the UE aggregation transmission, and at least one of the first UE and the second UE determines CSI-RS resources, performs measurement by using the determined CSI-RS resources, generates and report the measurement report.

In some implementations, in addition to a portion, an entire, or any combination of the described implementation(s)/embodiment(s), the second UE is determined to transmit the first UE's data to the base station.

In some implementations, in addition to a portion, an entire, or any combination of the described implementation(s)/embodiment(s), the determining the CSI-RS resources comprises: determining, by the second UE, one of the following CSI-RS resources for the second UE: all CSI-RS resources configured by the base station, a portion of the configured CSI-RS resources, or none of the configured CSI-RS resources.

In some implementations, in addition to a portion, an entire, or any combination of the described implementation(s)/embodiment(s), the second UE is determined to transmit the first UE's data to the base station, and the first UE does not transmit the first UE's data to the base station; and/or the second UE is determined to use all CSI-RS resources configured by the base station for measurement.

In some implementations, in addition to a portion, an entire, or any combination of the described implementation(s)/embodiment(s), the second UE is determined to transmit the first UE's data to the base station, and the first UE is determined to transmit the first UE's data to the base station; the second UE is determined to use a portion of all CSI-RS resources configured by the base station for measurement; and/or the second UE is determined to notify the first UE to use the CSI-RS resources from the all configured CSI-RS resources.

In some implementations, in addition to a portion, an entire, or any combination of the described implementation(s)/embodiment(s), the determining the CSI-RS resources comprises: determining, by the first UE, one of the following CSI-RS resources for the first UE: all CSI-RS resources configured by the base station, a portion of the configured CSI-RS resources, or none of the configured CSI-RS resources.

In some implementations, in addition to a portion, an entire, or any combination of the described implementation(s)/embodiment(s), the second UE is determined to transmit the first UE's data to the base station, and the first UE does not transmit the first UE's data to the base station; and/or the first UE is determined to notify the second UE to use all CSI-RS resources configured by the base station for measurement.

In some implementations, in addition to a portion, an entire, or any combination of the described implementation(s)/embodiment(s), the second UE is determined to transmit the first UE's data to the base station, and the first UE is determined to transmit the first UE's data to the base station; the first UE is determined to use a portion of all CSI-RS resources configured by the base station for measurement; and/or the first UE is determined to notify the second UE to use the CSI-RS resources from the all configured CSI-RS resources.

In some implementations, in addition to a portion, an entire, or any combination of the described implementation(s)/embodiment(s), the base station configures a CSI-RS resources for a paired UE set comprising the first UE and the second UE via common signaling; and/or each of the first UE and the second UE determines, within the configured CSI-RS resources, first CSI-RS resources for the first UE and second CSI-RS resources for the second UE, respectively.

In some implementations, in addition to a portion, an entire, or any combination of the described implementation(s)/embodiment(s), the first UE and the second UE, according to an ascending order of their cell-radio network temporary identifiers (C-RNTIs), determine the first CSI-RS resources for the first UE and the second CSI-RS resources for the second UE, respectively, among the CSI-RS resources for the paired UE set based on a continuous ascending order of an index of the CSI-RS resources for the paired UE set, the first UE and the second UE, according to a descending order of their C-RNTIs, determine the first CSI-RS resources for the first UE and the second CSI-RS resources for the second UE, respectively, among the CSI-RS resources for the paired UE set based on a continuous ascending order of an index of the CSI-RS resources for the paired UE set, the first UE and the second UE, according to an ascending order of their C-RNTIs, determine the first CSI-RS resources for the first UE and the second CSI-RS resources for the second UE, respectively, among the CSI-RS resources for the paired UE set based on a continuous descending order of an index of the CSI-RS resources for the paired UE set, or the first UE and the second UE, according to a descending order of their C-RNTIs, determine the first CSI-RS resources for the first UE and the second CSI-RS resources for the second UE, respectively, among the CSI-RS resources for the paired UE set based on a continuous descending order of an index of the CSI-RS resources for the paired UE set.

In some implementations, in addition to a portion, an entire, or any combination of the described implementation(s)/embodiment(s), the first UE and the second UE, according to an ascending order of their C-RNTIs, determine the first CSI-RS resources for the first UE and the second CSI-RS resources for the second UE, respectively, among the CSI-RS resources for the paired UE set based on an equal interval ascending order of an index of the CSI-RS resources for the paired UE set, the first UE and the second UE, according to a descending order of their C-RNTIs, determine the first CSI-RS resources for the first UE and the second CSI-RS resources for the second UE, respectively, among the CSI-RS resources for the paired UE set based on an equal interval ascending order of an index of the CSI-RS resources for the paired UE set, the first UE and the second UE, according to an ascending order of their C-RNTIs, determine the first CSI-RS resources for the first UE and the second CSI-RS resources for the second UE, respectively, among the CSI-RS resources for the paired UE set based on an equal interval descending order of an index of the CSI-RS resources for the paired UE set, or the first UE and the second UE, according to a descending order of their C-RNTIs, determine the first CSI-RS resources for the first UE and the second CSI-RS resources for the second UE, respectively, among the CSI-RS resources for the paired UE set based on an equal interval descending order of an index of the CSI-RS resources for the paired UE set.

In some implementations, in addition to a portion, an entire, or any combination of the described implementation(s)/embodiment(s), the first UE and the second UE, according to their role types in the paired UE set, determine the first CSI-RS resources for the first UE and the second CSI-RS resources for the second UE, respectively, among the CSI-RS resources for the paired UE set based on a continuous ascending order of an index of the CSI-RS resources for the paired UE set, or the first UE and the second UE, according to their role types in the paired UE set, determine the first CSI-RS resources for the first UE and the second CSI-RS resources for the second UE, respectively, among the CSI-RS resources for the paired UE set based on a continuous descending order of an index of the CSI-RS resources for the paired UE set.

In some implementations, in addition to a portion, an entire, or any combination of the described implementation(s)/embodiment(s), the first UE and the second UE, according to their role types in the paired UE set, determine the first CSI-RS resources for the first UE and the second CSI-RS resources for the second UE, respectively, among the CSI-RS resources for the paired UE set based on an equal interval ascending order of an index of the CSI-RS resources for the paired UE set, or the first UE and the second UE, according to their role types in the paired UE set, determine the first CSI-RS resources for the first UE and the second CSI-RS resources for the second UE, respectively, among the CSI-RS resources for the paired UE set based on an equal interval descending order of an index of the CSI-RS resources for the paired UE set.

In some implementations, in addition to a portion, an entire, or any combination of the described implementation(s)/embodiment(s), the second UE is determined to transmit the first UE's data to the base station, and the first UE does not transmit the first UE's data to the base station; and/or the second UE is determined to use all of the CSI-RS resources for the paired UE set, and the first UE is determined to use none of the CSI-RS resources for the paired UE set.

In some implementations, in addition to a portion, an entire, or any combination of the described implementation(s)/embodiment(s), the first UE and the second UE determine to use all of the CSI-RS resources for the paired UE set as the first CSI-RS resources for the first UE and the second CSI-RS resources for the second UE, respectively.

In some implementations, in addition to a portion, an entire, or any combination of the described implementation(s)/embodiment(s), the first UE has a first CSI measurement report and receives a second CSI measurement report from the second UE; the first UE cascades the first CSI measurement report and the second CSI measurement report to generate the measurement report; and/or the first UE reports the measurement report to the base station in the first UE's physical uplink control channel (PUCCH) or physical uplink shared channel (PUSCH).

In some implementations, in addition to a portion, an entire, or any combination of the described implementation(s)/embodiment(s), the first UE has a first CSI measurement report and receives a second CSI measurement report from the second UE; the first UE links the first CSI measurement report and the second CSI measurement report to serve as the measurement report; and/or the first UE reports the measurement report to the base station in the first UE's PUCCH or PUSCH.

In some implementations, in addition to a portion, an entire, or any combination of the described implementation(s)/embodiment(s), the second UE has a second CSI measurement report and receives a first CSI measurement report from the first UE; the second UE cascades the first CSI measurement report and the second CSI measurement report to generate the measurement report; and/or the second UE reports the measurement report to the base station in one of the following: the first UE's PUCCH, the first UE's PUSCH, the second UE's PUCCH, or the second UE's PUSCH.

In some implementations, in addition to a portion, an entire, or any combination of the described implementation(s)/embodiment(s), the second UE has a second CSI measurement report and receives a first CSI measurement report from the first UE; the second UE links the first CSI measurement report and the second CSI measurement report to serve as the measurement report; and/or the second UE reports the measurement report to the base station in one of the following: the first UE's PUCCH, the first UE's PUSCH, the second UE's PUCCH, or the second UE's PUSCH.

In some implementations, in addition to a portion, an entire, or any combination of the described implementation(s)/embodiment(s), the first CSI measurement report and the second CSI measurement report are concatenated to generate the measurement report based on their role types of the paired UE set.

In some implementations, in addition to a portion, an entire, or any combination of the described implementation(s)/embodiment(s), the first CSI measurement report of the first UE comprises a first CSI portion and a second CSI portion of the first UE; the second CSI measurement report of the second UE comprises a first CSI portion and a second CSI portion of the second UE; the first CSI portion of the first UE and the first CSI portion of the second UE are concatenated to obtain a concatenated first CSI portion based on their role types of the paired UE set; the second CSI portion of the first UE and the second CSI portion of the second UE are concatenated to obtain a concatenated second CSI portion based on their role types of the paired UE set; the concatenated first CSI portion is encoded and modulated to obtain first CSI modulation symbols; the concatenated second CSI portion is encoded and modulated to obtain second CSI modulation symbols; and/or the first CSI modulation symbols and the second CSI modulation symbols are transmitted in a same PUCCH or PUSCH.

In some implementations, in addition to a portion, an entire, or any combination of the described implementation(s)/embodiment(s), the first CSI measurement report and the second CSI measurement report are concatenated to generate the measurement report based on an ascending or descending order of their C-RNTIs of the paired UE set.

In some implementations, in addition to a portion, an entire, or any combination of the described implementation(s)/embodiment(s), the first CSI measurement report of the first UE comprises a first CSI portion and a second CSI portion of the first UE; the second CSI measurement report of the second UE comprises a first CSI portion and a second CSI portion of the second UE; the first CSI portion of the first UE and the first CSI portion of the second UE are concatenated to obtain a concatenated first CSI portion based on an ascending or descending order of their C-RNTIs of the paired UE set; the second CSI portion of the first UE and the second CSI portion of the second UE are concatenated to obtain a concatenated second CSI portion based on an ascending or descending order of their C-RNTIs of the paired UE set; the concatenated first CSI portion is encoded and modulated to obtain first CSI modulation symbols; the concatenated second CSI portion is encoded and modulated to obtain second CSI modulation symbols; and/or the first CSI modulation symbols and the second CSI modulation symbols are transmitted in a same PUCCH or PUSCH.

In some implementations, in addition to a portion, an entire, or any combination of the described implementation(s)/embodiment(s), the first CSI measurement report and the second CSI measurement report comprises portions with different priorities; high priority portions of the first and second CSI measurement reports are concatenated to generate a concatenated high priority portion of the measurement report based on their role types or an ascending or descending order of their C-RNTIs of the paired UE set; low priority portions of the first and second CSI measurement reports are concatenated to generate a concatenated low priority portion of the measurement report based on their role types or an ascending or descending order of their C-RNTIs of the paired UE set; and/or the concatenated high priority portion of the measurement report is placed before the concatenated low priority portion of the measurement report to generate the measurement report.

In some implementations, in addition to a portion, an entire, or any combination of the described implementation(s)/embodiment(s), the first CSI measurement report of the first UE comprises a first CSI portion and a second CSI portion of the first UE, each portion of which comprises portions with different priorities; the second CSI measurement report of the second UE comprises a first CSI portion and a second CSI portion of the second UE, each portion of which comprises portions with different priorities; high priority portions of the first CSI portion of the first UE and the first CSI portion of the second UE are concatenated to obtain a concatenated first high priority CSI portion based on their role types or an ascending or descending order of their C-RNTIs of the paired UE set; low priority portions of the first CSI portion of the first UE and the first CSI portion of the second UE are concatenated to obtain a concatenated first low priority CSI portion based on their role types or an ascending or descending order of their C-RNTIs of the paired UE set; high priority portions of the second CSI portion of the first UE and the second CSI portion of the second UE are concatenated to obtain a concatenated second high priority CSI portion based on their role types or an ascending or descending order of their C-RNTIs of the paired UE set; low priority portions of the second CSI portion of the first UE and the second CSI portion of the second UE are concatenated to obtain a concatenated second low priority CSI portion based on their role types or an ascending or descending order of their C-RNTIs of the paired UE set; and/or the measurement report is generated by concatenating the following in the order of: the concatenated first high priority portion, the concatenated first low priority portion, the concatenated second high priority portion, and the concatenated second low priority portion.

In some implementations, in addition to a portion, an entire, or any combination of the described implementation(s)/embodiment(s), the first UE is configured to transmit the measurement report to the base station in the first UE's PUCCH or PUSCH.

In some implementations, in addition to a portion, an entire, or any combination of the described implementation(s)/embodiment(s), the first UE is configured to transmit the measurement report to the base station in the first UE's PUSCH with same modulation as the first UE's PUSCH and with same beta value corresponding to the first UE's PUSCH.

In some implementations, in addition to a portion, an entire, or any combination of the described implementation(s)/embodiment(s), the second UE is configured to transmit the measurement report to the base station in the first UE's PUCCH or PUSCH, or in the second UE's PUCCH or PUSCH.

In some implementations, in addition to a portion, an entire, or any combination of the described implementation(s)/embodiment(s), the second UE is configured to transmit the measurement report to the base station in the first UE's PUSCH with same modulation as the first UE's PUSCH and with same beta value corresponding to the first UE's PUSCH; or the second UE is configured to transmit the measurement report to the base station in the second UE's PUSCH with same modulation as the second UE's PUSCH and with same beta value corresponding to the second UE's PUSCH.

In various embodiments, a paired UEs may perform CSI measurements based on the CSI-RS resources configured by either the base station or one of the paired UEs according to one of the following methods. In some implementations for non-limiting example, the paired UEs includes a first UE (UE1) and a second UE (UE2), and the UE1's data may be transmitted to a base station by the UE2, i.e., the UE1 is an anchor UE and the UE2 is an assistant UE.

For one method (Method A1), when the UE1 and the UE2 are paired for aggregated transmission and the UE2 interacts with the base station to configure the CSI-RS resources and reports the CSI measurement results, the CSI-RS resources used for measurement by the UE2 are configured by the base station, and the UE2 reports the final measurement results to the base station. The final measurement results include the measurement results of the UE1 and/or the UE2.

In some implementations, the UE2 performs measurements by using all CSI-RS resources configured by the base station. Alternatively, the UE2 performs measurements by using a portion of the configured CSI-RS resources, while the UE1 performs measurements by using a portion of the configured CSI-RS resources, such as the remaining CSI-RS resources unused by the UE2. In this case, the CSI-RS resources used by the UE1 are notified by the UE2.

In some implementations, the UE2 determines that all, a portion/part (the part can also be 0), or none of the configured CSI-RS resources are used to measure based on the signaling notification of the base station. Alternatively, the UE2 determines that all, a portion/part (the part can also be 0), or none of the configured CSI-RS resources are used for measurement based on aggregation transmission mode.

In some implementations, the transmission mode includes at least one of the following: a first mode wherein the UE2 transmits the UE1's data, but the UE1 does not transmit the UE1 data, then all CSI-RS resources are used to perform measurements by the UE2; and a second mode wherein the UE1 and the UE2 respectively transmit the same or different the UE1's data, then a portion of the configured CSI-RS resources are used to perform measurements by the UE2, and a portion of the configured CSI-RS resources (e.g., the rest) are used to perform measurements by the UE1. The CSI-RS resources used by the UE1 are notified by the UE2.

For another method (Method A2), when the UE1 and the UE2 are paired for aggregated transmission and the UE1 interacts with the base station to configure the CSI-RS resources and reports the CSI measurement results, the CSI-RS resources used for measurement by the UE1 are configured by the base station, and the UE1 reports the final measurement results to the base station. The final measurement results include the measurement results of the UE1 and/or the UE2.

In some implementations, the UE1 performs measurements by using all CSI-RS resources configured by the base station. Alternatively, the UE1 performs measurements by using a portion of the configured CSI-RS resources, while the UE2 performs measurements by using a portion of the configured CSI-RS resources, such as the remaining CSI-RS resources unused by the UE1. In this case, the CSI-RS resources used by the UE2 are notified by the UE1.

In some implementations, the UE1 determines that all, a portion/part (the part can also be 0), or none of the configured CSI-RS resources are used to measure based on the signaling notification of the base station. Alternatively, the UE1 determines that all, a portion/part (the part can also be 0), or none of the configured CSI-RS resources are used for measurement based on aggregation transmission mode.

In some implementations, the transmission mode includes at least one of the following: a first mode wherein the UE2 transmits the UE1's data, the UE1 does not transmit the UE1 data, and all CSI-RS resources are used to perform measurements by the UE2; and a second mode wherein the UE1 and the UE2 respectively transmit the same or different the UE1's data, a portion of the configured CSI-RS resources are used to perform measurements by the UE1, and a portion of the configured CSI-RS resources (e.g., the rest) are used to perform measurements by the UE2. The CSI-RS resources used by the UE2 are notified by the UE1.

For another method (Method A3), the base station configures CSI-RS resources for the paired UEs (for example, through common signaling), and the paired UEs respectively performs measurements by using all, a portion/part (the part can also be 0), or none of the configured CSI-RS resources. The measurement results of the UE1 and the measurement results of the UE2 are reported through one of the paired UEs or through the paired UEs, respectively. The base station and the paired UEs may agree on which UE can report the final measurement results including the measurement results of the UE1 (if there is any) and the measurement results of the UE2 (if there is any). It may also be that the base station may signal which UE to report the final measurement results.

In some implementations, the base station configures CSI-RS resources for the paired UEs. The UE1 and the UE2 respectively determine their CSI-RS resources from the configured CSI-RS resources based on at least one of the following predefined methods (or predefined rules). For example, the UE1 and the UE2 respectively determine the amount of CSI-RS resources used for measurement based on the number of their own antenna ports.

For one predefined method/rule (Method B1), determining CSI-RS resources for each paired UE is based on the ascending (or descending) order of the C-RNTI of the paired UEs and/or the ascending (or descending) order of the index (or position) of the configured CSI-RS resources. The UE1 and the UE2 may respectively determine their respective CSI-RS resources based on C-RNTI ascending (or descending) order from the configured CSI-RS resources.

For a non-limiting example, suppose 8 CSI-RS resources with indexes 0-7 are configured for paired UEs, and the C-RNTI of the UE1 is smaller than that of the UE2. The UE1 may determine that four CSI-RS resources are needed, such as based on the number of antenna ports of the UE1. The UE2 also determines that four CSI-RS resources are needed, such as based on the number of antenna ports of the UE2. The UE1 determines four CSI-RS resources from the configured CSI-RS resources based on the ascending (or descending) order of the index (or position) of the configured CSI-RS resources, that is, four CSI-RS resources with indexes 0 to 3 are determined based on the ascending order of the index (or position) of the configured CSI-RS resources. The UE2 determines four CSI-RS resources from the remaining configured CSI-RS resources based on the ascending (or descending) order of the index (or position) of the configured CSI-RS resources, that is, four CSI-RS resources with indexes 4 to 7 are determined based on the ascending order of the index (or position) of the configured CSI-RS resources.

For another non-limiting example, when 8 CSI-RS resources with indexes 0-7are configured for the paired UEs, and the C-RNTI of the UE1 is smaller than that of the UE2, the UE1 determines that four CSI-RS resources are needed, such as based on the number of antenna ports of the UE1. The UE2 also determines that four CSI-RS resources are needed, such as based on the number of antenna ports of the UE2. The UE1 determines four CSI-RS resources from the configured CSI-RS resources based on the equal interval ascending (or descending) order of the index (or position) of the configured CSI-RS resources, that is, four CSI-RS resources with indexes 0, 2, 4 and 6 are determined. the UE2 determines four CSI-RS resources from the remaining configured CSI-RS resources based on the equal interval ascending (or descending) order of the index (or position) of the configured CSI-RS resources, that is, four CSI-RS resources with indexes 1, 3, 5 and 7 are determined. From the perspective of one UE among the paired UEs, the interval of the index can be determined based on the number of paired UEs. When n UEs are paired, the interval of the index is n, wherein n is an integer larger than one, for example, 2, 3, 4, 5, etc.

For another predefined method/rule (Method B2), determining CSI-RS resources for each paired UE is based on the role type of the paired UEs and/or the ascending (or descending) order of the index (or position) of the configured CSI-RS resources. The role type of the paired UE includes whether the paired UE is an assistant UE or an anchor UE. In some implementations, the UE1 and the UE2 may respectively determine their respective CSI-RS resources based on C-RNTI ascending (or descending) order from the configured CSI-RS resources.

For a non-limiting example, when 8 CSI-RS resources with indexes 0-7 are configured for paired UEs, and the UE1 is an anchor UE, and the UE2 is an assistant UE. The base station and UE agree that the anchor UE determines CSI-RS resources before the assistant UE (or vice versa, adaptive modification is sufficient). The UE1 determines that four CSI-RS resources are needed, such as based on the number of antenna ports of the UE1. The UE2 also determines that four CSI-RS resources are needed, such as based on the number of antenna ports of the UE2. The UE1 determines four CSI-RS resources from the configured CSI-RS resources based on the ascending (or descending) order of the index (or position) of the configured CSI-RS resources, that is, four CSI-RS resources with indexes 0 to 3 are determined according to the ascending order of the index of the configured CSI-RS resources. The UE2 determines four CSI-RS resources from the remaining configured CSI-RS resources based on the ascending (or descending) order of the index (or position) of the configured CSI-RS resources, that is, four CSI-RS resources with indexes 4 to 7 are determined according to the ascending order of the index of the configured CSI-RS resources.

For another non-limiting example, when 8 CSI-RS resources with indexes 0-7 are configured for paired UEs, and the UE1 is an anchor UE, and the UE2 is an assistant UE. The base station and UE agree that the anchor UE determines CSI-RS resources before the assistant UE (or vice versa, adaptive modification is sufficient). The UE1 determines that four CSI-RS resources are needed, such as based on the number of antenna ports of the UE1. The UE2 also determines that four CSI-RS resources are needed, such as based on the number of antenna ports of the UE2. The UE1 determines four CSI-RS resources from the configured CSI-RS resources based on the equal interval ascending (or descending) order of the index (or position) of the configured CSI-RS resources, that is, four CSI-RS resources with indexes 0, 2, 4 and 6 are determined according to the ascending order of the index of the configured CSI-RS resources. The UE2 determines four CSI-RS resources from the remaining configured CSI-RS resources based on the equal interval ascending (or descending) order of the index (or position) of the configured CSI-RS resources, that is, four CSI-RS resources with indexes 1, 3, 5 and 7 are determined according to the ascending order of the index of the configured CSI-RS resources. From the perspective of one UE among the paired UEs, the interval of the index can be determined based on the number of paired UEs. When n UEs are paired, the interval of the index is n, wherein n is an integer larger than one, for example, 2, 3, 4, 5, etc.

In some implementations, when the UE1 does not need to transmit the UE1's data and only the UE2 transmits the UE1's data, the number of CSI-RS resources determined by the UE2 is equal to the number of configured CSI-RS resources, that is, all configured CSI-RS resources may be determined to be used by the UE2. The UE1 determines that the number of CSI-RS resources used by the UE1 is 0.

For another predefined method/rule (Method B3), the UE1 may determine that the number of CSI-RS resources used for measurement is equal to the number of configured CSI-RS resources, and the UE2 may also determine that the number of CSI-RS resources used for measurement is equal to the number of configured CSI-RS resources. That is to say, the UE1 and the UE2 respectively use all configured CSI-RS for measurement. In this case, the UE1 and the UE2 may transmit the same or different UE1's data separately. For example, the UE1 and the UE2 may use the same time-frequency resources to simultaneously transmit the same the UE1's data through the same encoding and modulation method.

In some implementations, when the UE1 and the UE2 are paired and the UE1 and the UE2 are each other's assistant UE and anchor UE, the UE1 may use all configured CSI-RS resources for measurement, and the UE2 may also use all configured CSI-RS resources for measurement.

In some implementations, the base station and the UE may agree that CSI-RS resources (including all CSI-RS resources) used by the UE1 or the UE2 for measurement are determined based on aggregated transmission from the configured CSI-RS resources. In some implementations, the base station may explicitly or implicitly notify the CSI-RS resources used by the UE1 or the UE2 for measurement from the configured CSI-RS resources via signaling.

In various embodiments, the final measurement results mentioned above may be reported by one of the UE1 and/or the UE2, or may be reported by both the UE1 and the UE2.

In some implementations, the base station and UE may agree that the UE1 or the UE2 report the final measurement result. When the final measurement result is determined to be transmitted by the UE1, the final measurement result is transmitted by the UE1 in the UE1's PUCCH or the UE1's PUSCH. When the final measurement result is determined to be transmitted by the UE2, the final measurement result is transmitted by the UE2 in the UE1's PUCCH or the UE1's PUSCH or the UE2's PUCCH or the UE2's PUSCH.

In some implementations, the final CSI measurement result contains the measurement results of the UE1 and/or the UE2, which can be reported by the UE1 in the UE1's PUSCH by using the same modulation as the UE1's PUSCH and using the beta value corresponding to the UE1's PUSCH. In various embodiment/implementations, the beta value may be used to determine the number of resources for the final CSI measurement result from the PUSCH resource. The usage method of the beta value may be pre-defined.

In some implementations, the final CSI measurement result contains the measurement results of the UE1 and/or the UE2, which can be reported by the UE2 in the UE1's PUSCH by using the same modulation as the UE1's PUSCH and using the beta value corresponding to the UE1's PUSCH.

In some implementations, the final CSI measurement result contains the measurement results of the UE1 and/or the UE2, which can be reported by the UE2 in the UE2's PUSCH by using the same modulation as the UE2's PUSCH and using the beta value corresponding to the UE2's PUSCH.

In some implementations, when the UE1 is scheduled to transmit PUCCH and PUSCH and the PUCCH overlaps with the PUSCH in the time domain, the PUSCH may ultimately be transmitted by the UE2 (that is, the PUSCH is scheduled for the UE1, but the UE1 does not transmit the PUSCH). In this case, the information in the PUCCH is not multiplexed by the UE2 in the PUSCH, and the PUCCH is transmitted by the UE1.

In some implementations, the base station and UE agree to determine which UE reports the final measurement result based on the aggregation transmission method or predefined conditions. For example, when the base station is unaware of the assistant UE, the UE1 reports the final measurement result; and/or when the base station knows the assistant UE, the UE2 reports the final measurement result.

In some implementations, when the UE1 and the UE2 transmit the same UE1's data, the UE1 and the UE2 report the final measurement results separately.

In some implementations, when the UE1 and the UE2 transmit different UE1's data, the UE1 and the UE2 report the final measurement results separately.

In some implementations, when the UE2 transmits the UE1's data and the UE1 does not transmit the UE1's data, the UE2 reports the final measurement result.

In some implementations, when the UE1 and the UE2 transmit the same the UE1's data through the same time-frequency resources and the same encoding and modulation method, the UE1 and the UE2 report the final measurement result through the same time-frequency resources and encoding and modulation method.

In various embodiments, the final measurement report may be generated. Exemplary examples of the measurement result of the CSI are described, which is also applicable to other measurement result. The final measurement result corresponds to the final CSI measurement result/final CSI report, which is formed based on one of the following methods.

For one method (Method C1), when the UE1 reports the final CSI report, the UE1 interacts with the UE2 and obtains the CSI measurement results of the UE2. The UE1 generates the final CSI report. The CSI measurement results of the UE1 and the UE2 are cascaded to form a final CSI report, which is transmitted to the base station by the UE1. In some implementations, alternatively, the CSI measurement results of the UE2 are formed into a CSI report 2 by the UE2. The UE1 interacts with the UE2 and obtains the UE2's CSI report 2. The measurement results of the UE1 are formed into a CSI report 1 by the UE1. CSI Report 1 and CSI Report 2 are cascaded and formed into a final CSI report, which is reported in the UE1's PUCCH or the UE1's PUSCH by the UE1.

For another method (Method C2), when the UE1 reports the final CSI report, the CSI measurement results of the UE1 are formed into a CSI report 1 by the UE1, and the CSI measurement results of the UE2 are formed into a CSI report 2 by the UE2. The UE1 interacts with the UE2 and obtains the UE2's CSI report 2. The CSI Report 1 and CSI Report 2 may be linked and reported separately by the UE1. That is to say, in this case, the final CSI report is actually two associated CSI reports 1 and CSI report 2. The two associated CSI reports serve as the final CSI reports and are transmitted in the UE1's PUCCH or the UE1's PUSCH by the UE1.

For another method (Method C3): similar to Method C1 or C2, when the UE2, instead of the UE1, reports the final CSI report, the above Method C1 or C2 may be modified accordingly. For a non-limiting example, the UE2 obtains the CSI measurement results of the UE1 or the CSI report of the UE1. The UE2 forms the final CSI report. The final measurement result is transmitted by the UE2 in the UE1's PUCCH or the UE1's PUSCH or the UE2's PUCCH or the UE2's PUSCH.

In various embodiments, when the final CSI report is one CSI report, the CSI measurement results of different UE may be cascaded based on at least one of the following methods.

For one method (Method D1), the CSI measurement results of the UE1 and the UE2 are concatenated in the final CSI report based on the role type of the paired UE. The role type of the paired UE includes assistant UE and anchor UE. For example, the base station and UE agree that the CSI measurement results of the anchor UE are placed before the CSI measurement results of the assistant UE, or vice versa. For example, when the CSI measurement results of the UE1 and the UE2 are formed into one CSI report, in this CSI report, the CSI measurement results of the UE1 are placed before the measurement results of the UE2 to obtain the one CSI report. The one CSI report serves as the final CSI report. Furthermore, assuming that the CSI measurement results of the UE1 and CSI measurement results of the UE2 contain two parts: CSI-1 information and CSI-2 information. The necessary decoding information of CSI-2 information is included in CSI-1 information. The CSI-1 information of the UE1 and the UE2 is concatenated based on the role type of the paired UE, and the CSI-2 information the UE1 and the UE2 is concatenated based on the role type of the paired UE. Then the concatenated CSI-1 information is placed before the concatenated CSI-2 information, and vice versa. For example, the CSI-1 information of the UE1 is placed before the CSI-1 information of the UE2 to obtain the concatenated CSI-1 information. The CSI-2 information of the UE1 is placed before the CSI-2 information of the UE2 to obtain the concatenated CSI-2information. The concatenated CSI-1 information is placed before the concatenated CSI-2 information to obtain the final CSI report.

In some implementations, the concatenated CSI-1 information may be encoded and modulated to obtain the CSI-1 modulation symbol, and the concatenated CSI-2 information may be encoded and modulated to obtain the CSI-2 modulation symbol. The CSI-1 modulation symbol and CSI-2 modulation symbol may be transmitted in the same PUCCH or PUSCH.

For another method (Method D2), the CSI measurement results of the UE1 and the CSI measurement results the UE2 are concatenated in the final CSI report based on the ascending or descending order of the paired UE's C-RNTI. For example, when the C-RNTI of the UE1 is smaller than that of the UE2 and the ascending order of C-RNTI is used and the CSI measurement results of the UE1 and the UE2 are formed into one CSI report, in this CSI report, the CSI measurement results of the UE1 are placed before the measurement results of the UE2 to obtain the one CSI report. The one CSI report serves as the final CSI report.

In some implementations, the CSI measurement results of the UE1 and CSI measurement results of the UE2 contain two parts: CSI-1 information and CSI-2 information. The necessary decoding information of CSI-2 information is included in CSI-1 information. The CSI-1 information of the UE1 and the UE2 is concatenated based on the ascending or descending order of the paired UE's C-RNTI, and the CSI-2 information the UE1 and the UE2 is concatenated based on the ascending or descending order of the paired UE's C-RNTI. Then the concatenated CSI-1 information is placed before the concatenated CSI-2 information, and vice versa. For example, the CSI-1 information of the UE1 is placed before the CSI-1 information of the UE2 to obtain the concatenated CSI-1 information based on the ascending order of the C-RNTIs of the UE1 and the UE2. The CSI-2 information of the UE1 is placed before the CSI-2 information of the UE2 to obtain the concatenated CSI-2 information based on the ascending order of the C-RNTIs of the UE1 and the UE2. The concatenated CSI-1 information is placed before the concatenated CSI-2 information to obtain the final CSI report.

In some implementations, the concatenated CSI-1 information may be encoded and modulated to obtain the CSI-1 modulation symbol, and the concatenated CSI-2 information may be encoded and modulated to obtain the CSI-2 modulation symbol. The CSI-1 modulation symbol and CSI-2 modulation symbol may be transmitted in the same PUCCH or PUSCH.

For another method (Method D3), on the basis of Method D1 and Method D2, Method D3 may considers the priority of the CSI report, which means that the CSI report may contain CSI measurement results of different priorities. For example, the CSI measurement results of the UE1 may include high priority CSI measurement results and low priority CSI measurement results. The CSI measurement results of the UE2 include high priority CSI measurement results and low priority CSI measurement results.

In some implementations, the concatenation method in Method D1 or Method D2 may be used to obtain the concatenated high priority CSI measurement results between high priority CSI measurement results for different UEs.

In some implementations, the concatenation method in Method D1 or Method D2 may be used to obtain the concatenated low priority CSI measurement results between low priority CSI measurement results for different UEs.

In some implementations, CSI-1 may be placed before CSI-2, regardless of the priority of CSI measurement results.

In some implementations, the concatenated high priority CSI measurement results may be placed before the concatenated low priority CSI measurement results, and vice versa. In this way, the final CSI report is obtained in the order of being concatenated: the concatenated high priority CSI measurement results, and the concatenated low priority CSI measurement results.

In some implementations, the CSI report may also include CSI-1 and CSI-2. In this way, a high priority CSI report contains both high priority CSI-1 and high priority CSI-2. A low-priority CSI report contains both low-priority CSI-1 and low-priority CSI-2.

In some implementations, the concatenation method in Method D1 or Method D2 may be used to obtain the concatenated high priority CSI-1 measurement results between high priority CSI-1 measurement results for different UEs.

In some implementations, the concatenation method in Method D1 or Method D2 may be used to obtain the concatenated high priority CSI-2 measurement results between high priority CSI-2 measurement results for different UEs.

In some implementations, the concatenation method in Method D1 or Method D2 may be used to obtain the concatenated low priority CSI-1 measurement results between low priority CSI-1 measurement results for different UEs.

In some implementations, the concatenation method in Method D1 or Method D2 may be used to obtain the concatenated low priority CSI-2 measurement results between low priority CSI-2 measurement results for different UEs.

In some implementations, CSI-1 may be placed before CSI-2, regardless of the priority of CSI measurement results.

In this way, the final CSI report is obtained in the order of being concatenated: the concatenated high priority CSI-1 measurement results, the concatenated high priority CSI-2 measurement results, the concatenated low priority CSI-1 measurement results and the concatenated low priority CSI-2 measurement results.

In various embodiments, a new UE capability may be introduced. The new UE capability describes whether the UE can (or cannot) form and report the final CSI report for the above method. When the paired UE reports having the new UE capability, the base station can configure the UE to form and report the final CSI report mentioned above.

Various embodiments/implementation described in the present disclosure may also be applicable to the HARQ-ACK information of the UE1 and the HARQ-ACK information of the UE2. That is to say, the CSI measurement result of the UE1 is equivalent to the HARQ-ACK of the UE1, and the CSI measurement result of the UE2 is equivalent to the HARQ-ACK of the UE2.

The present disclosure describes methods, apparatus, and computer-readable medium for wireless communication. The present disclosure addressed the issues with forming measurement results under UE aggregation transmission. The methods, devices, and computer-readable medium described in the present disclosure may facilitate the performance of wireless communication, thus improving efficiency and overall performance. The methods, devices, and computer-readable medium described in the present disclosure may improves the overall efficiency of the wireless communication systems.

In some other embodiments, a computer-readable medium comprising instructions which, when executed by a computer, cause the computer to carry out the above methods. The computer-readable medium may be referred as non-transitory computer-readable media (CRM) that stores data for extended periods such as a flash drive or compact disk (CD), or for short periods in the presence of power such as a memory device or random access memory (RAM). In some embodiments, computer-readable instructions may be included in a software, which is embodied in one or more tangible, non-transitory, computer-readable media. Such non-transitory computer-readable media can be media associated with user-accessible mass storage as well as certain short-duration storage that are of non-transitory nature, such as internal mass storage or ROM. The software implementing various embodiments of the present disclosure can be stored in such devices and executed by a processor (or processing circuitry). A computer-readable medium can include one or more memory devices or chips, according to particular needs. The software can cause the processor (including CPU, GPU, FPGA, and the like) to execute particular processes or particular parts of particular processes described herein, including defining data structures stored in RAM and modifying such data structures according to the processes defined by the software.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments, for non-limiting examples, a portion from one or more embodiment may be combined with another portion of other embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

What is claimed is:

1. A method for wireless communication, comprising:
forming measurement result under user equipment (UE) aggregation transmission, wherein a first UE and a second UE are paired for the UE aggregation transmission, by:
determining, by at least one of the first UE and the second UE, channel state information reference signal (CSI-RS) resources;
performing, by the at least one of the first UE and the second UE, measurement by using the determined CSI-RS resources;
generating, by the at least one of the first UE and the second UE, a measurement report; and
reporting, by the at least one of the first UE and the second UE, the measurement report to a base station.

2. A method for wireless communication, comprising:
configuring, by a base station, channel state information reference signal (CSI-RS) resources; and
receiving, by the base station, a measurement report under user equipment (UE) aggregation transmission, wherein a first UE and a second UE are paired for the UE aggregation transmission, and at least one of the first UE and the second UE determines the CSI-RS resources, performs measurement by using the determined CSI-RS resources, generates and report the measurement report.

3. The method according to claim 1, wherein:
the second UE is determined to transmit the first UE's data to the base station.

4. The method according to claim 1, wherein the determining the CSI-RS resources comprises:
determining, by the second UE, one of the following CSI-RS resources for the second UE:
all CSI-RS resources configured by the base station,
a portion of the configured CSI-RS resources, or
none of the configured CSI-RS resources.

5. The method according to claim 1, wherein:
the second UE is determined to transmit the first UE's data to the base station, and the first UE does not transmit the first UE's data to the base station; and
the second UE is determined to use all CSI-RS resources configured by the base station for measurement.

6. The method according to claim 1, wherein:
the second UE is determined to transmit the first UE's data to the base station, and the first UE is determined to transmit the first UE's data to the base station;
the second UE is determined to use a portion of all CSI-RS resources configured by the base station for measurement; and
the second UE is determined to notify the first UE to use the CSI-RS resources from the all configured CSI-RS resources.

7. The method according to claim 1, wherein the determining the CSI-RS resources comprises:
determining, by the first UE, one of the following CSI-RS resources for the first UE:
all CSI-RS resources configured by the base station,
a portion of the configured CSI-RS resources, or
none of the configured CSI-RS resources.

8. The method according to claim 1, wherein:
the second UE is determined to transmit the first UE's data to the base station, and the first UE does not transmit the first UE's data to the base station; and
the first UE is determined to notify the second UE to use all CSI-RS resources configured by the base station for measurement.

9. The method according to claim 1, wherein:
the second UE is determined to transmit the first UE's data to the base station, and the first UE is determined to transmit the first UE's data to the base station;
the first UE is determined to use a portion of all CSI-RS resources configured by the base station for measurement; and
the first UE is determined to notify the second UE to use the CSI-RS resources from the all configured CSI-RS resources.

10. The method according to claim 1, wherein:
the base station configures the CSI-RS resources for a paired UE set comprising the first UE and the second UE via common signaling; and
each of the first UE and the second UE determines, within the configured CSI-RS resources, first CSI-RS resources for the first UE and second CSI-RS resources for the second UE, respectively.

11. The method according to claim 10, wherein:
the first UE and the second UE, according to an ascending order of their cell-radio network temporary identifiers (C-RNTIs), determine the first CSI-RS resources for the first UE and the second CSI-RS resources for the second UE, respectively, among the CSI-RS resources for the paired UE set based on a continuous ascending order of an index of the CSI-RS resources for the paired UE set,
the first UE and the second UE, according to a descending order of their C-RNTIs, determine the first CSI-RS resources for the first UE and the second CSI-RS resources for the second UE, respectively, among the CSI-RS resources for the paired UE set based on a continuous ascending order of an index of the CSI-RS resources for the paired UE set; or
the first UE and the second UE, according to an ascending order of their C-RNTIs, determine the first CSI-RS resources for the first UE and the second CSI-RS resources for the second UE, respectively, among the CSI-RS resources for the paired UE set based on a continuous descending order of an index of the CSI-RS resources for the paired UE set, or
the first UE and the second UE, according to a descending order of their C-RNTIs, determine the first CSI-RS resources for the first UE and the second CSI-RS resources for the second UE, respectively, among the CSI-RS resources for the paired UE set based on a continuous descending order of an index of the CSI-RS resources for the paired UE set; or
the first UE and the second UE, according to an ascending order of their C-RNTIs, determine the first CSI-RS resources for the first UE and the second CSI-RS resources for the second UE, respectively, among the CSI-RS resources for the paired UE set based on an equal interval ascending order of an index of the CSI-RS resources for the paired UE set; or
the first UE and the second UE, according to a descending order of their C-RNTIs, determine the first CSI-RS resources for the first UE and the second CSI-RS resources for the second UE, respectively, among the CSI-RS resources for the paired UE set based on an equal interval ascending order of an index of the CSI-RS resources for the paired UE set; or
the first UE and the second UE, according to an ascending order of their C-RNTIs, determine the first CSI-RS resources for the first UE and the second CSI-RS resources for the second UE, respectively, among the CSI-RS resources for the paired UE set based on an equal interval descending order of an index of the CSI-RS resources for the paired UE set; or
the first UE and the second UE, according to a descending order of their C-RNTIs, determine the first CSI-RS resources for the first UE and the second CSI-RS resources for the second UE, respectively, among the CSI-RS resources for the paired UE set based on an equal interval descending order of an index of the CSI-RS resources for the paired UE set; or
the first UE and the second UE, according to their role types in the paired UE set, determine the first CSI-RS resources for the first UE and the second CSI-RS resources for the second UE, respectively, among the CSI-RS resources for the paired UE set based on a continuous ascending order of an index of the CSI-RS resources for the paired UE set, ; or
the first UE and the second UE, according to their role types in the paired UE set, determine the first CSI-RS resources for the first UE and the second CSI-RS resources for the second UE, respectively, among the CSI-RS resources for the paired UE set based on a continuous descending order of an index of the CSI-RS resources for the paired UE set; or
the first UE and the second UE, according to their role types in the paired UE set, determine the first CSI-RS resources for the first UE and the second CSI-RS resources for the second UE, respectively, among the CSI-RS resources for the paired UE set based on an equal interval ascending order of an index of the CSI-RS resources for the paired UE set; or
the first UE and the second UE, according to their role types in the paired UE set, determine the first CSI-RS resources for the first UE and the second CSI-RS resources for the second UE, respectively, among the CSI-RS resources for the paired UE set based on an equal interval descending order of an index of the CSI-RS resources for the paired UE set; or
the second UE is determined to transmit the first UE's data to the base station, and the first UE does not transmit the first UE's data to the base station; and the second UE is determined to use all of the CSI-RS resources for the paired UE set, and the first UE is determined to use none of the CSI-RS resources for the paired UE set; or
the first UE and the second UE determine to use all of the CSI-RS resources for the paired UE set as the first CSI-RS resources for the first UE and the second CSI-RS resources for the second UE, respectively.

12-16. (canceled)

17. The method according to claim 1, wherein:
the first UE has a first CSI measurement report and receives a second CSI measurement report from the second UE;
the first UE cascades the first CSI measurement report and the second CSI measurement report to generate the measurement report; and
the first UE reports the measurement report to the base station in the first UE's physical uplink control channel (PUCCH) or physical uplink shared channel (PUSCH).

18. The method according to claim 1, wherein:
the first UE has a first CSI measurement report and receives a second CSI measurement report from the second UE;
the first UE links the first CSI measurement report and the second CSI measurement report to serve as the measurement report; and
the first UE reports the measurement report to the base station in the first UE's PUCCH or PUSCH.

19. The method according to claim 1, wherein:
the second UE has a second CSI measurement report and receives a first CSI measurement report from the first UE;
the second UE cascades the first CSI measurement report and the second CSI measurement report to generate the measurement report; and
the second UE reports the measurement report to the base station in one of the following: the first UE's PUCCH, the first UE's PUSCH, the second UE's PUCCH, or the second UE's PUSCH.

20. The method according to claim 1, wherein:
the second UE has a second CSI measurement report and receives a first CSI measurement report from the first UE;
the second UE links the first CSI measurement report and the second CSI measurement report to serve as the measurement report; and
the second UE reports the measurement report to the base station in one of the following:
the first UE's PUCCH, the first UE's PUSCH, the second UE's PUCCH, or the second UE's PUSCH.

21. The method according to claim 17, wherein:
the first CSI measurement report and the second CSI measurement report are concatenated to generate the measurement report based on their role types of the paired UE set; or
the first CSI measurement report of the first UE comprises a first CSI portion and a second CSI portion of the first UE; the second CSI measurement report of the second UE comprises a first CSI portion and a second CSI portion of the second UE; the first CSI portion of the first UE and the first CSI portion of the second UE are concatenated to obtain a concatenated first CSI portion based on their role types of the paired UE set; the second CSI portion of the first UE and the second CSI portion of the second UE are concatenated to obtain a concatenated second CSI portion based on their role types of the paired UE set; the concatenated first CSI portion is encoded and modulated to obtain first CSI modulation symbols; the concatenated second CSI portion is encoded and modulated to obtain second CSI modulation symbols; and the first CSI modulation symbols and the second CSI modulation symbols are transmitted in a same PUCCH or PUSCH; or
the first CSI measurement report and the second CSI measurement report are concatenated to generate the measurement report based on an ascending or descending order of their C-RNTIs of the paired UE set; or the first CSI measurement report of the first UE comprises a first CSI portion and a second CSI portion of the first UE; the second CSI measurement report of the second UE comprises a first CSI portion and a second CSI portion of the second UE; the first CSI portion of the first UE and the first CSI portion of the second UE are concatenated to obtain a concatenated first CSI portion based on an ascending or descending order of their C-RNTIs of the paired UE set; the second CSI portion of the first UE and the second CSI portion of the second UE are concatenated to obtain a concatenated second CSI portion based on an ascending or descending order of their C-RNTIs of the paired UE set; the concatenated first CSI portion is encoded and modulated to obtain first CSI modulation symbols; the concatenated second CSI portion is encoded and modulated to obtain second CSI modulation symbols; and the first CSI modulation symbols and the second CSI modulation symbols are transmitted in a same PUCCH or PUSCH; or
the first CSI measurement report and the second CSI measurement report comprise portions with different priorities; high priority portions of the first and second CSI measurement reports are concatenated to generate a concatenated high priority portion of the measurement report based on their role types or an ascending or descending order of their C-RNTIs of the paired UE set; low priority portions of the first and second CSI measurement reports are concatenated to generate a concatenated low priority portion of the measurement report based on their role types or an ascending or descending order of their C-RNTIs of the paired UE set; and the concatenated high priority portion of the measurement report is placed before the concatenated low priority portion of the measurement report to generate the measurement report; or
the first CSI measurement report of the first UE comprises a first CSI portion and a second CSI portion of the first UE, each portion of which comprises portions with different priorities; the second CSI measurement report of the second UE comprises a first CSI portion and a second CSI portion of the second UE, each portion of which comprises portions with different priorities; high priority portions of the first CSI portion of the first UE and the first CSI portion of the second UE are concatenated to obtain a concatenated first high priority CSI portion based on their role types or an ascending or descending order of their C-RNTIs of the paired UE set; low priority portions of the first CSI portion of the first UE and the first CSI portion of the second UE are concatenated to obtain a concatenated first low priority CSI portion based on their role types or an ascending or descending order of their C-RNTIs of the paired UE set; high priority portions of the second CSI portion of the first UE and the second CSI portion of the second UE are concatenated to obtain a concatenated second high priority CSI portion based on their role types or an ascending or descending order of their C-RNTIs of the paired UE set; low priority portions of the second CSI portion of the first UE and the second CSI portion of the second UE are concatenated to obtain a concatenated second low priority CSI portion based on their role types or an ascending or descending order of their C-RNTIs of the paired UE set; and the measurement report is generated by concatenating the following in the order of: the concatenated first high priority portion, the concatenated first low priority portion, the concatenated second high priority portion, and the concatenated second low priority portion.

22-26. (canceled)

27. The method according to claim 1, wherein:
the first UE is configured to transmit the measurement report to the base station in the first UE's PUCCH or PUSCH; or
the second UE is configured to transmit the measurement report to the base station in the first UE's PUCCH or PUSCH, or in the second UE's PUCCH or PUSCH.

28. The method according to claim 27, wherein:
in response to that the first UE is configured to transmit the measurement report to the base station in the first UE's PUCCH or PUSCH, the first UE is configured to transmit the measurement report to the base station in the first UE's PUSCH with same modulation as the first UE's PUSCH and with same beta value corresponding to the first UE's PUSCH; or
in response to that the second UE is configured to transmit the measurement report to the base station in the first UE's PUCCH or PUSCH, or in the second UE's PUCCH or PUSCH, the second UE is configured to transmit the measurement report to the base station in the first UE's PUSCH with same modulation as the first UE's PUSCH and with same beta value corresponding to the first UE's PUSCH; or the second UE is configured to transmit the measurement report to the base station in the second UE's PUSCH with same modulation as the second UE's PUSCH and with same beta value corresponding to the second UE's PUSCH.

29-30. (canceled)

31. A wireless communications apparatus comprising a processor and a memory, wherein the processor is configured to read code from the memory and implement operations of:
forming measurement result under user equipment (UE) aggregation transmission, wherein a first UE and a second UE are paired for the UE aggregation transmission, by:
determining, by at least one of the first UE and the second UE, channel state information reference signal (CSI-RS) resources;
performing, by the at least one of the first UE and the second UE, measurement by using the determined CSI-RS resources;
generating, by the at least one of the first UE and the second UE, a measurement report; and
reporting, by the at least one of the first UE and the second UE, the measurement report to a base station.

32. A computer program product comprising a computer-readable program medium code stored thereupon, the computer-readable program medium code, when executed by a processor, causing the processor to implement a method recited in claim 1.
